(19) United States
(12) Patent Application Publication
(10) Pub. No.: US 2025/0222910 A1
(43) Pub. Date: Jul. 10, 2025

(54) ELECTRO-MECHANICAL BRAKE AND CONTROL METHOD THEREFOR

(71) Applicant: HYUNDAI MOBIS CO., LTD., Seoul (KR)

(72) Inventor: Dong Hwan LIM, Yongin-si (KR)

(73) Assignee: HYUNDAI MOBIS CO., LTD., Seoul (KR)

(21) Appl. No.: 18/978,575

(22) Filed: Dec. 12, 2024

(30) Foreign Application Priority Data
Jan. 8, 2024 (KR) 10-2024-0003085

(51) Int. Cl. B60T 13/74; B60T 17/22

(52) U.S. Cl. CPC B60T 13/741; B60T 17/221

(57) ABSTRACT

An electro-mechanical brake including a piston configured to push a brake pad toward a wheel disk through driving of a motor, the electro-mechanical brake including: a current detection unit configured to detect an actual current value flowing through the motor; a position detection unit configured to detect an actual piston position of the piston; an effective value extraction unit configured to filter the actual current value and extract an effective value from the actual current value; and an actual braking force value detection unit configured to detect an actual braking force value based on a first map, a second map, the actual piston position, and the effective value, wherein the first map is a map in which a correlation relationship between a current flowing through the motor, a position of the piston, and a braking force in a first state is converted into data, the second map is a map in which the current flowing through the motor and a factor in the first state are converted into data, and the factor is a ratio of the braking force to the current flowing through the motor.

### CROSS-REFERENCE TO RELATED APPLICATIONS

The present application claims priority to Patent Application No. 10-2024-0003085, filed on Jan. 8 2024 in Korea, the entire contents of which are incorporated herein by reference.

### TECHNICAL FIELD

The present disclosure relates to an electro-mechanical brake and a control method therefor.

### BACKGROUND

The content described in this section simply provides background information for the present disclosure and does not constitute the related art.

An electro-mechanical brake (EMB) is a brake apparatus that generates a friction braking force. In the electro-mechanical brake, an actuator that is driven by a motor is mounted on a brake caliper. The electro-mechanical brake presses a wheel disk using a motor, a gear box, a screw, a piston, a brake pad, and the like without a medium called a brake fluid.

The electro-mechanical brake has a similar mechanism to an electronic parking brake (EPB), but the electro-mechanical brake is required to have higher reliability and durability since the electro-mechanical brake is a main braking apparatus that is used during traveling. When a driver steps on a pedal, the electro-mechanical brake calculates a required braking force and applies a brake command to each wheel. When the brake command is applied, the motor starts rotating and moving the piston forward, and the piston presses the brake pad. The brake pad presses the wheel disk to generate the braking force.

An electro-mechanical brake (EMB) of the related art measures a braking force using a force sensor and controls the braking force. The force sensor mounted on the electro-mechanical brake is expensive. In addition, the force sensor has a disadvantage that the force sensor does not accurately measure the braking force depending on a position at which the force sensor is mounted. To overcome the disadvantage, a force sensor-less system is used.

The force sensor-less system refers to a system that estimates a braking force without using a force sensor. An electro-mechanical brake to which the force sensor-less system has been applied performs calibration. Here, the calibration refers to a process of setting the electro-mechanical brake. The electro-mechanical brake can perform the calibration to ascertain a braking force value corresponding to a position of a piston. A map in which braking force values corresponding to positions of the piston are indexed is called a force map. With the force map, the electro-mechanical brake can ascertain the braking force without a force sensor and adjust the braking force.

Since a state of the electro-mechanical brake changes with use, for example, brake pads wear out, the calibration must be performed and information of the electro-mechanical brake must be updated each time a vehicle is used. It is preferable to perform the calibration before starting traveling. For example, when a driver opens a door of a vehicle or starts up the vehicle, the calibration can be performed and the force map can be generated.

That is, an electro-mechanical brake using a force sensor-less system may perform calibration to ascertain a current state of the electro-mechanical brake and generate data for estimating a braking force. It is important that the calibration is completed quickly. This is because a driver can travel after the calibration is completed.

The calibration is usually performed only when the driver opens a door of a vehicle or starts up the vehicle. It is not preferable to perform the calibration during traveling. This is because a process of performing the calibration includes a process of driving a motor to move a piston and a brake pad, and a process of generating a braking force. When the calibration is performed regardless of the driver's will during traveling, the driver may feel braking heterogeneity and a traffic accident may occur.

A force map generated when the driver opens the door of the vehicle or starts up the vehicle reflects only a state of the electro-mechanical brake at a point in time when the force map has been generated. The force map cannot reflect in real time the state of the electro-mechanical brake that has changed due to braking during traveling. For example, when the braking is performed during traveling, brake pads may wear out and the stiffness of the brake pads may change. Thus, a method capable of accurately estimating a braking force without performing additional calibration is required when the state of the electro-mechanical brake is different from the state at the point in time when the force map has been generated due to the braking during traveling. This is because it is not preferable to perform the calibration during traveling, as described above. That is, a method capable of accurately estimating a braking force during driving is required.

### SUMMARY

Therefore, the present disclosure has been made to solve these problems, and a main object of the present disclosure is to provide a method capable of accurately detecting a braking force without performing additional calibration when a state of an electro-mechanical brake changes from a state before traveling due to braking performed during traveling.

The problems to be solved by the present disclosure are not limited to the problems described above, and other problems not described can be clearly understood by those skilled in the art from the description below.

An electro-mechanical brake including a piston configured to push a brake pad toward a wheel disk through driving of a motor, the electro-mechanical brake comprising: a current detection unit configured to detect an actual current value flowing through the motor; a position detection unit configured to detect an actual piston position of the piston; an effective value extraction unit configured to filter the actual current value and extract an effective value from the actual current value; and an actual braking force value detection unit configured to detect an actual braking force value based on a first map, a second map, the actual piston position, and the effective value, wherein the first map is a map in which a correlation relationship between a current flowing through the motor, a position of the piston, and a braking force in a first state is converted into data, the second map is a map in which the current flowing through the motor and a factor in the first state are converted into data, and the factor is a ratio of the braking force to the current flowing through the motor.

A control method for an electro-mechanical brake including a piston configured to push a brake pad toward a wheel disk through driving of a motor, the control method comprising: generating a first map and a second map in a first state; detecting an actual piston position of the piston; detecting an actual current value flowing through the motor; filtering the actual current value to extract an effective value from the actual current value; and detecting an actual braking force value based on the first map, the second map, the actual piston position, and the effective value, wherein the first map is a map in which a correlation relationship between a current flowing through the motor, a position of the piston, and a braking force in the first state is converted into data, the second map is a map in which the current flowing through the motor and a factor in the first state are converted into data, and the factor is a ratio of the braking force to the current flowing through the motor.

As described above, according to the present embodiment, the electro-mechanical brake has an effect that it is possible to accurately detect a braking force without performing additional calibration when a state of the electro-mechanical brake changes from a state before traveling due to braking performed during traveling.

### BRIEF DESCRIPTION OF THE DRAWINGS

FIG. 1 is a functional block diagram of an electro-mechanical brake according to an embodiment of the present disclosure.

FIG. 2 is a diagram illustrating a braking force generation unit according to an embodiment of the present disclosure.

FIG. 3 is a graph showing a relationship between a current flowing through a motor and a braking force according to an embodiment of the present disclosure.

FIG. 4 is a diagram illustrating data that the electro-mechanical brake collects to generate a first map and/or a second map according to an embodiment of the present disclosure.

FIG. 5 is a graph showing the state of the electro-mechanical brake according to a movement state of the piston according to an embodiment of the present disclosure.

FIG. 6 is a graph showing a first curve and a second curve according to an embodiment of the present disclosure.

FIG. 7 is a flowchart showing a control method for an electro-mechanical brake according to an embodiment of the present disclosure.

FIG. 8 is a flowchart illustrating detailed step S750 in FIG. 7 according to an embodiment of the present disclosure.

FIG. 9 is a flowchart illustrating detailed step S700 in FIG. 7 according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

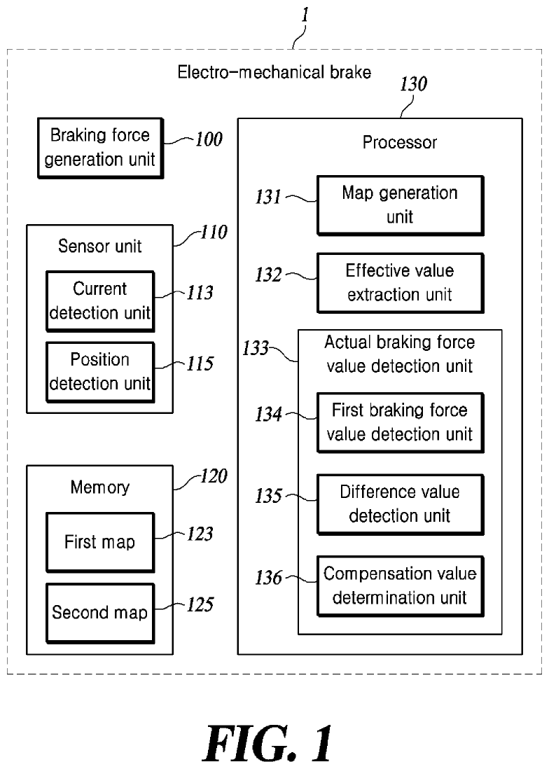

FIG. 1 is a functional block diagram of an electro-mechanical brake according to an embodiment of the present disclosure.

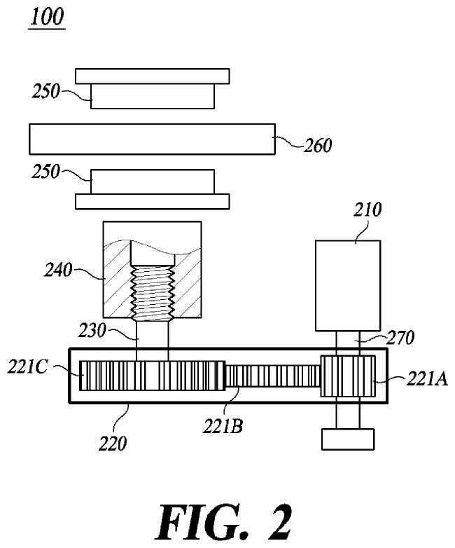

FIG. 2 is a diagram illustrating a braking force generation unit according to an embodiment of the present disclosure.

Referring to FIGS. 1 and 2, an electro-mechanical brake (EMB) 1 includes all or some of a braking force generation unit 100, a sensor unit 110, a memory 120, and a processor 130. The electro-mechanical brake 1 generates a friction braking force. Since the electro-mechanical brake 1 does not use hydraulic pressure, the electro-mechanical brake 1 has a higher response speed and is more environmentally friendly than a hydraulic brake (not shown). The electro-mechanical brake 1 is capable of independent control of each wheel (not shown), thereby providing high braking stability.

When a driver steps on a brake pedal (not shown), the braking force generation unit 100 calculates a required braking force based on a stroke amount of the driver and then generates the braking force. The braking force generation unit 100 may be mounted on a wheel of a vehicle to generate the braking force. The braking force generation unit 100 may be mounted on each wheel of the vehicle. The braking force generation unit 100 is capable of independent braking force generation and independent control for each wheel.

The braking force generation unit 100 changes kinetic energy of the vehicle into heat energy using a friction force, and brakes the vehicle.

The braking force generation unit 100 may include all or some of a motor 210, a gear box 220, a power transfer unit 230, a piston 240, a brake pad 250, a rotation shaft 270, and a wheel disk 260. The braking force generation unit 100 is not limited by the disclosure in the drawings. For example, a shape, size, disposition, and the like of the motor 210, the gear box 220, the power transfer unit 230, the piston 240, the brake pad 250, the rotation shaft 270, and the wheel disk 260 are not limited by the disclosure in the drawings.

The motor 210 rotates to move the piston 240. A direction of the piston 240 used in the present specification is defined. Forward movement means that the piston 240 moves toward the wheel disk 260. Backward movement means that the piston 240 moves in an opposite direction of the wheel disk 260.

According to an embodiment, the motor 210 may be a direct current motor (DC Motor), an alternating current motor (AC Motor), an induction motor, a synchronous motor, a step motor, a servo motor, a brushless direct current motor (BLDC motor), a linear motor, a permanent magnet synchronous motor (PMSM), or the like.

One side of the gear box 220 is connected to the motor 210, and the other side of the gear box 220 is connected to the power transfer unit 230. The gear box 220 is configured to transfer the power of the motor 210 to the power transfer unit 230. The gear box 220 includes a plurality of gears 221 therein. In the gear box 220, the plurality of gears 221 are engaged and rotated so that a rotational force can be amplified. A shape and disposition of the gear box 220 are not limited by the drawings. The plurality of gears 221 are not limited to the shape and the number shown in the drawings.

The power transfer unit 230 may receive power from the gear box 220. The power transfer unit 230 may provide the power to the piston 240.

According to one embodiment, the power transfer unit 230 may be a screw shaft. In this case, the piston 240 may be screw coupled to the screw shaft. In this case, when the screw shaft rotates, the screw coupling is connected or disconnected, and the piston 240 moves forward or backward.

The piston 240 moves with the power transferred from the power transfer unit 230. When the piston 240 moves forward, the piston 240 presses the brake pad 250. The brake pad 250 presses the rotating wheel disk 260 to brake the vehicle.

A pair of brake pads 250 may be provided. The pair of brake pads 250 may be disposed on both sides of the wheel disk 260. The wheel disk 260 is coupled to the wheel of the vehicle and rotates with the wheel. When the piston 240 presses the brake pad 250, the brake pad 250 may press the wheel disk 260. When the brake pad 250 presses the wheel disk 260, the brake pad 250 is compressed and a braking force is generated. As a distance by which the piston 240 moves forward increases, a force with which the brake pad 250 presses the wheel disk 260 increases, and thus, the braking force increases.

The sensor unit 110 may include a current detection unit 113, a position detection unit 115, and the like.

According to one embodiment, the current detection unit 113 may detect a current flowing through the motor 210. For example, a current sensor (not shown) may be included to detect the current flowing through the motor 210. The electro-mechanical brake 1 can control the current flowing through the motor 210 using the current detection unit 113.

According to one embodiment, the position detection unit 115 may detect the position of the piston 240. For example, the position detection unit 115 may include a motor rotation angle sensor (not shown) to detect a rotation angle of the motor 210. As the motor 210 rotates, the piston 240 moves forward or backward. That is, since the position of the piston 240 is determined by the rotation angle of the motor 210, the electro-mechanical brake 1 may detect the position of the piston 240 using the position detection unit 115 including the motor rotation angle sensor.

A state of the electro-mechanical brake 1 that is used in the present specification is defined. A first state refers to a state of the electro-mechanical brake 1 when traveling and braking have not yet been performed. For example, the first state may be a state of the electro-mechanical brake 1 when electrica power is applied to the vehicle due to start-up. For example, the first state may be a state of the electro-mechanical brake 1 when a door of a vehicle of which an engine is turned off opens.

When braking is performed during traveling, the state of the electro-mechanical brake 1 may change from the first state to another state. For example, when the brake pad 250 is worn, a physical property thereof may change. That is, the stiffness may change.

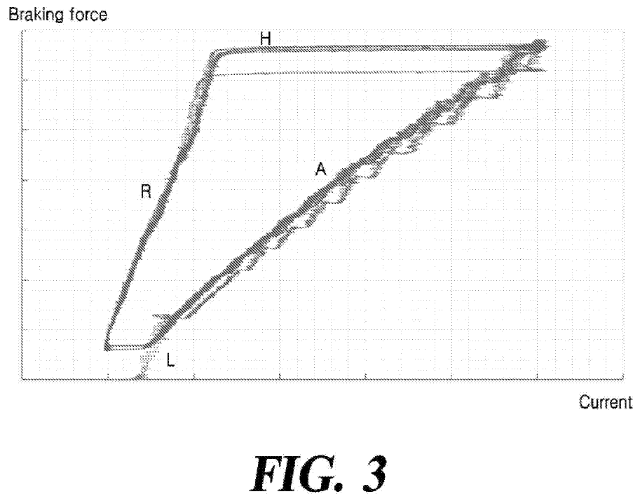

FIG. 3 is a graph showing a relationship between a current flowing in a motor and a braking force according to an embodiment of the present disclosure.

Referring to FIG. 3, an x-axis on the graph represents the current flowing through the motor 210, and a y-axis on the graph represents a braking force by the electro-mechanical brake 1. Each section on the graph of FIG. 3 will be described. Section A is a section in which the brake is applied and is a section in which the driver steps on the brake pedal to increase the braking force. Section His a section in which a state in which the driver steps on the brake pedal is held, and is a section in which the braking force is held substantially constant. Section R is a section in which the driver releases the brake pedal, and is a section in which the braking force rapidly decreases. Section L is a section in which the braking force is so low that the braking force cannot be detected.

Section A will be described in greater detail. Section A is a section in which the piston 240 moves forward due to the motor 210 and presses the brake pad 250. Section A is a section in which the brake pad 250 moves forward to press the wheel disk 260 and generate a braking force. Section A is a section in which the braking force increases linearly as the current increases.

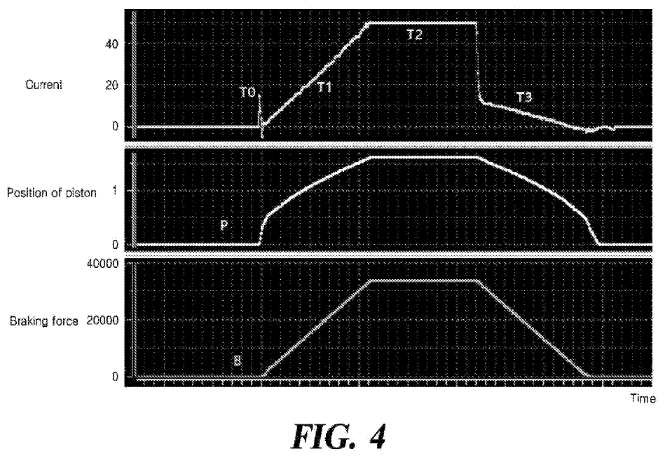

A position of the piston 240 when the piston 240 starts moving forward due to the motor 210 and the brake pad 250 and the wheel disk 260 spaced apart start coming into contact with each other is called a contact point. In section A, a magnitude of the current flowing through the motor 210 increases as the piston 240 moves forward. As the piston 240 moves away from the contact point, the magnitude of the current increases. The electro-mechanical brake 1 according to the present disclosure may detect a current value for the position of the piston 240, converts a correlation relationship between the position of the piston 240, the current flowing through the motor 210, and the braking force into data, and generate a first map 123 and/or a second map 125. This will be described in greater detail in FIG. 4.

FIG. 4 is a diagram illustrating data that the electro-mechanical brake collects to generate the first map and/or the second map according to an embodiment of the present disclosure.

Referring to FIG. 4, an x-axis represents time, and a y-axis represents the current flowing through the motor 210, the position of the piston 240, and the braking force of the electro-mechanical brake 1. When the electro-mechanical brake 1 according to the present disclosure is in the first state, the electro-mechanical brake 1 can generate the first map 123 and/or the second map 125. In order to generate the first map 123 and/or the second map 125, the electro-mechanical brake 1 collects the current flowing through the motor 210, the position of the piston 240, and the braking force in the first state.

In order to collect data regarding the current flowing through the motor 210, the position of the piston 240, and the braking force, the electro-mechanical brake 1 may perform RAMP control. Here, the RAMP control means performing control so that the current flowing through the motor 210 and/or the position of the piston 240 gradually increases in the first state. When STEP control that rapidly changes the position of the piston 240 is performed, a current according to the position of the piston 240 cannot be accurately measured, and thus, the electro-mechanical brake 1 according to the present disclosure performs the RAMP control to collect the data regarding the current flowing through the motor 210, the position of the piston 240, and the braking force. In the RAMP control, an inrush current TO is generated at a moment the brake pad 250 and the wheel disk 260 come into contact with each other and a braking force is generated. Referring to section T1 in FIG. 4, as the piston 240 moves forward, the current and the braking force increase.

The electro-mechanical brake 1 can collect data in section T1 in which the current flowing through the motor 210, the position of the piston 240, and the braking force increase with time. The electro-mechanical brake 1 may generate the first map 123 and/or the second map 125 based on the collected data.

In a process of collecting the data, the current flowing through the motor 210 may be detected using the current detection unit 113, and the position of the piston 240 may be detected using the position detection unit 115. As described with reference to FIG. 3, when the electro-mechanical brake 1 is applied, the braking force increases linearly as the current flowing through the motor 210 increases, and thus, when the current flowing through the motor 210 is detected, a braking force value corresponding to the current value can be estimated.

The first map 123 and/or the second map 125 may be stored in the memory 120. The first map 123 is a map in which the correlation relationship between the current flowing through the motor 210, the position of the piston 240, and the braking force is converted into data in the first state. The second map 125 is a map in which the current flowing through the motor 210 and the factor are converted into data in the first state. The factor is a ratio of a braking force to the current flowing through the motor 210. That is, the factor is a braking force divided by a current.

TABLE 1

| piston | Braking | |
|---|---|---|
| position | force | current |
| 0 | 0 | 0.1 |
| 0.29 | 0 | 0.2 |
| 0.3 | 0 | 0.3 |
| 0.35 | 204 | 0.8 |
| 0.4 | 424 | 0.9 |
| 0.45 | 862 | 1 |
| 0.5 | 1472 | 1.6 |
| 0.55 | 2254 | 2.6 |
| 0.6 | 3302 | 3.85 |
| 0.65 | 4382 | 5 |
| 0.7 | 5556 | 7.1 |
| 0.75 | 6746 | 8.3 |
| 0.8 | 7966 | 10.1 |
| 0.85 | 9234 | 11.8 |
| 0.9 | 10534 | 13.6 |
| 0.95 | 11832 | 15.5 |
| 1 | 13210 | 17.1 |
| 1.05 | 14618 | 19 |
| 1.1 | 16058 | 21.8 |
| 1.15 | 17528 | 23.7 |
| 1.2 | 19046 | 25.9 |
| 1.25 | 20674 | 28.8 |
| 1.3 | 22302 | 30.7 |
| 1.35 | 23976 | 34.5 |
| 1.4 | 25776 | 36.9 |
| 1.45 | 27560 | 39.3 |
| 1.5 | 29314 | 41.7 |
| 1.55 | 31128 | 44.2 |
| 1.6 | 32948 | 46.8 |

Table 1 shows an embodiment of the first map 123 generated based on the data collected by performing the RAMP control. According to the embodiment, the first map 123 may be a look-up table. When the first map 123 is the look-up table, an output value can be obtained quickly. For example, when the position value of 0.55 of the piston 240 is input to the first map 123, a current value of 2.6 and a braking force value of 2254 corresponding to the position value of 0.55 of the piston 240 can be quickly output.

TABLE 2

| piston | Braking | | |
|---|---|---|---|
| position | force | current | factor |
| 0 | 0 | 0.1 | 0 |
| 0.29 | 0 | 0.2 | 0 |
| 0.3 | 0 | 0.3 | 0 |
| 0.35 | 204 | 0.8 | 255 |
| 0.4 | 424 | 0.9 | 471 |
| 0.45 | 862 | 1 | 862 |
| 0.5 | 1472 | 1.6 | 920 |
| 0.55 | 2254 | 2.6 | 867 |
| 0.6 | 3302 | 3.85 | 858 |
| 0.65 | 4382 | 5 | 876 |
| 0.7 | 5556 | 7.1 | 783 |
| 0.75 | 6746 | 8.3 | 813 |
| 0.8 | 7966 | 10.1 | 789 |
| 0.85 | 9234 | 11.8 | 783 |
| 0.9 | 10534 | 13.6 | 775 |
| 0.95 | 11832 | 15.5 | 763 |
| 1 | 13210 | 17.1 | 773 |
| 1.05 | 14618 | 19 | 769 |
| 1.1 | 16058 | 21.8 | 737 |
| 1.15 | 17528 | 23.7 | 740 |
| 1.2 | 19046 | 25.9 | 735 |
| 1.25 | 20674 | 28.8 | 718 |
| 1.3 | 22302 | 30.7 | 726 |
| 1.35 | 23976 | 34.5 | 695 |
| 1.4 | 25776 | 36.9 | 699 |
| 1.45 | 27560 | 39.3 | 701 |
| 1.5 | 29314 | 41.7 | 703 |
| 1.55 | 31128 | 44.2 | 704 |
| 1.6 | 32948 | 46.8 | 704 |

Table 2 shows an example of the second map 125 generated based on the data collected by performing the RAMP control. The factor in Table 2 is the braking force divided by the current flowing through the motor 210. The factor may be used to detect the accurate actual braking force when the state of the electro-mechanical brake 1 changes from the first state to another state. According to the example, the second map 125 may be a look-up table. When the second map 125 is the look-up table, an output value can be obtained quickly. For example, when a current value of 2.6 flowing through the motor 210 is input to the second map 125, a factor value of 867 corresponding to the current value of 2.6 can be quickly output.

The processor 130 may include, for example, a map generation unit 131, an effective value extraction unit 132, and an actual braking force value detection unit 133.

The map generation unit 131 may generate the first map 123 in the first state. Since the first map 123 is the map in which the correlation relationship between the current flowing through the motor 210, the position of the piston 240, and the braking force is converted into the data in the first state, it is preferable for the first map 123 to be generated before traveling of the vehicle starts. This is because the state of the electro-mechanical brake 1 changes from the first state when traveling and braking are performed. According to one embodiment, the map generation unit 131 may start generating the first map 123 from a moment the user opens the door of the vehicle. According to one embodiment, the map generation unit 131 may start generating the first map 123 immediately after electric power is applied to the vehicle due to start-up.

The map generation unit 131 may generate the second map 125 in the first state. Since the second map 125 is a map in which the factor that is the ratio of the braking force to the current flowing through the motor 210 is converted into data in the first state, it is preferable for the second map 125 to be generated before traveling of the vehicle starts. This is because the state of the electro-mechanical brake 1 changes from the first state when the traveling and the braking are performed. According to one embodiment, the map generation unit 131 may start generating the second map 125 from the moment the user opens the door of the vehicle. According to one embodiment, the map generation unit 131 may start generating the second map 125 immediately after electric power is applied to the vehicle due to start-up.

The effective value extraction unit 132 extracts an effective value from the actual current value. The actual current value refers to a value of an actual current flowing through the motor 210 detected by the current detection unit 113 when braking is performed during traveling. Among values of the actual current flowing through the motor 210, the actual current value that can be used to detect the actual braking force value is called the effective value. In other words, the actual current values that are not the effective value among the actual current values cannot be used to detect the actual braking force value. The actual braking force value refers to a value of the actual braking force generated by the electro-mechanical brake 1 when braking is performed during traveling.

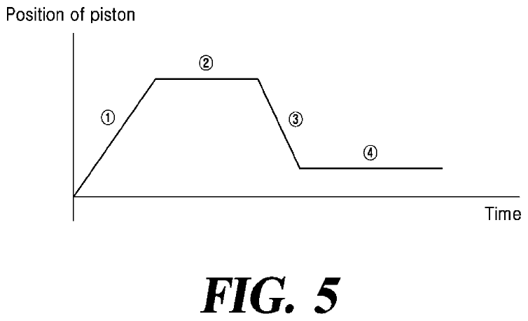

FIG. 5 is a graph showing the state of the electro-mechanical brake according to a movement state of the piston according to an embodiment of the present disclosure.

Referring to FIG. 5, a vertical axis of the graph represents the position of the piston 240, and a horizontal axis represents time. The state of the electro-mechanical brake 1 can be divided into four states depending on the movement state of the piston 240.

In state \textcircled{1}, the piston 240 moves forward toward the wheel disk 260. That is, a differential value of the position of the piston 240 with respect to time is positive. In other words, state \textcircled{1} represents an applied state in which the brake is applied and the braking force is generated.

In state \textcircled{3}, the piston 240 moves backward with time. That is, the differential value of the position of the piston 240 with respect to time is negative. That is, state \textcircled{3} is a released state in which the brake is released.

In state \textcircled{2} and state \textcircled{4}, the position of the piston 240 does not change. That is, the differential value of the position of the piston 240 with respect to time is 0. State \textcircled{2} and state \textcircled{4} are distinguished depending on a movement state of the piston 240 immediately before the piston 240 stops. When the differential value of the position of the piston 240 is positive before the piston 240 stops, the state of the electro-mechanical brake 1 is state \textcircled{2}, and when the differential value of the position of the piston 240 is negative before the piston 240 stops, the state of the electro-mechanical brake 1 is state \textcircled{4}. State \textcircled{2} and state \textcircled{4} are both states in which the brake is held, but can be distinguished from each other. Specifically, state \textcircled{2} is an apply-held state that the brake is held during applying, and state \textcircled{4} is a release-held state that the brake is held during release.

When the effective value is extracted from the actual current value, a method of extracting the effective value may be applied differently depending on the state of the electro-mechanical brake described above. This will be described later.

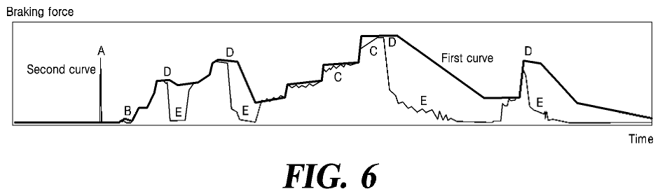

FIG. 6 is a graph showing a first curve and a second curve according to an embodiment of the present disclosure.

Referring to FIG. 6, the first curve and the second curve are curves derived by performing an experiment in which the electro-mechanical brake 1 is irregularly applied, released, application-held, and release-held. In the drawing, the first curve is expressed as a thicker line than the second curve.

The first curve is a curve obtained by measuring the braking force of the electro-mechanical brake 1 using a force sensor. Since the electro-mechanical brake 1 according to the present disclosure adopts a force sensor-less system, the force sensor is not included as a component. That is, the first curve is merely shown to explain the second curve.

The second curve is a curve representing the braking force of the electro-mechanical brake 1 detected using the actual current value flowing through the motor 210. Among parts of the second curve, a part in which the first curve matches the braking force is a part in which the braking force is detected using the effective value extracted from the actual current value. A part of the second curve that does not match the first curve is a part in which the braking force is detected using the actual current value rather than the effective value. The electro-mechanical brake 1 according to the present disclosure extracts the effective value and accurately estimates the braking force value using the effective value. In other words, since the actual braking force value is detected using the effective value, estimation accuracy that is the same as or similar to that measured by the force sensor is obtained.

Hereinafter, characteristics of a part in which the first curve and the second curve match and characteristics of a part in which the curves do not match will be described. In addition, conditions for the effective value that must be extracted from the actual current value will be described.

Part A is a part in which the stopped piston 240 just starts moving. In part A, since the current is unstable due to an inrush current of the motor 210, the braking force has a large error between the first curve and the second curve.

Part B is a part in which the brake pad 250 and the wheel disk 260 start coming into contact with each other due to a movement of the piston 240 and the braking force starts being generated. That is, since part B is a part in which switching from an unloaded state to a loaded state occurs, the current value is unstable and the braking force has a large error between the first curve and the second curve. According to one embodiment, the effective value extraction unit 132 may extract, as the effective value, an actual current value detected when an actual piston position is a position to which the piston has moved forward by a preset distance or more from the contact point. That is, the effective value extraction unit 132 does not extract, as the effective value, the actual current values detected in parts A and B because noise is large, and extracts, as the effective value, the actual current value detected when the piston 240 moves forward by the preset distance or more from the contact point. This is because the current becomes stable when the piston 240 moves forward the preset distance or more from the contact point. Here, the preset distance may be set differently depending on specifications of the vehicle and the electro-mechanical brake.

Part C represents an applied state in which the piston 240 moves forward and the brake pad 250 presses the wheel disk 260 so that a braking force is generated. Part C includes a part in which a slope is relatively steep and a part in which the slope is relatively gentle.

In part C, when a brake command (or a target braking force) decreases rapidly or a rate of change in the brake command (or a rate of change in target braking force) decreases rapidly, a current applied to the motor 210 is greatly reduced in order to reduce an output of the motor 210, and thus, the braking force has a large error between the first curve and the second curve. According to one embodiment, the effective value extraction unit 132 may extract, as the effective value, an actual current value of which a rate in change during a specific time period has a positive value among the actual current values, in the applied state in which the piston 240 is moving forward. That is, the effective value extraction unit 132 may extract, as the effective value, the actual current value detected when a rate of change in the current applied to the motor 210 is maintained at a positive value. That is, when the rate of change in the actual current value has a positive value during the specific time period, the effective value extraction unit 132 may extract the actual current value as the effective value. This is because the braking force increases due to the forward movement of the piston 240 when the rate of change in the actual current value has a positive value. In general, when the current applied to the motor 210 rapidly decreases, it is difficult to estimate the braking force based on the current. However, when the rate of change in the current applied to the motor 210 is maintained at the positive value in the applied state as described above, the braking force estimated based on the current is reliable, and thus, the effective value extraction unit 132 may extract the effective value from the actual current valid. Here, the specific time period may be set differently depending on the specifications of the vehicle and the electro-mechanical brake.

Part D represents an apply-held state in which the piston 240 moves forward and then stops.

According to one embodiment, the effective value extraction unit 132 may extract, as the effective value, the actual current value detected when the first braking force value is smaller than the target braking force (or the brake command). This is because, when the first braking force value is smaller than the target braking force (or the brake command), the braking force must be increased, and thus, a magnitude of the current applied to the motor 210 is maintained or increased so that the braking force between the first curve and the second curve is substantially similar.

According to one embodiment, in a case where the piston 240 moves forward, stops, and then maintains a stop state (maintains the apply-held state), the effective value extraction unit 132 may extract, as the effective value, the actual current value when the first braking force value is smaller than the target braking force (or the brake command) and the stop state is maintained during a threshold time period or less. That is, the effective value extraction unit 132 may extract, as the effective value, the actual current value detected while the apply-held state is maintained during the threshold time period or less. In the apply-held state, basically, when the first braking force value is smaller than the target braking force (or the brake command), the effective value can be detected. However, when the apply-held state is maintained in excess of the threshold time period (that is, a holding time is longer), noise increases due to change in the current flowing through the motor 210, and thus, it is difficult to detect the effective value. Therefore, when the apply-held state is maintained, the effective value extraction unit 132 may extract, as the effective value, the actual current value when the first braking force value is smaller than the target braking force and the stop state is maintained during the threshold time period or less. The threshold time period may be set differently depending on the specifications of the vehicle and the electro-mechanical brake.

According to one embodiment, when the piston 240 moves forward, stops, and then maintains the stop state (maintains the apply-held state), the effective value extraction unit 132 may extract, as the effective value, the actual current value when a rage of change in the target braking force during a control time period (or a rate of change in the brake command) remains positive. Here, the control time period must be larger than twice the highest control cycle. The highest control cycle refers to a time period from a point in time when the brake command is applied to a point in time when the motor 210 is operated. Here, the control time period must be shorter than a piston position control stabilization time. The piston position control stabilization time refers to a time period from a point in time when the piston 240 starts moving according to the brake command to a point in time when the piston 240 stops.

Part E represents a released state or a release-held state in which the piston 240 moves backwards and the pressure of the brake pad 250 with respect to the wheel disk 260 decreases. In the case of the released state or the release-held state, it is difficult to extract the effective value. However, even in the released state or the release-held state, the effective value may be extracted when the piston momentarily enters the applied state or the apply-held state.

When braking is performed during traveling, the actual braking force value detection unit 133 may detect the actual braking force value based on the actual piston position, the effective value, the first map 123, and the second map 125. The actual piston position refers to an actual position of the piston 240 detected by the position detection unit 115 when braking is performed during traveling. The actual current value refers to a value of the actual current flowing through the motor 210 detected by the current detection unit 113 when the braking is performed during driving. The actual braking force value refers to a value of the actual braking force generated by the electro-mechanical brake 1 when braking is performed during traveling.

An electro-mechanical brake 1 without a force sensor of the related art estimates the braking force with the first state as a reference. Since the state of the electro-mechanical brake 1 continuously changes from the first state due to braking performed during traveling, the electro-mechanical brake 1 of the related art has a disadvantage that the accuracy of the actual braking force value detected as traveling continues decreases.

The electro-mechanical brake 1 according to the present disclosure can overcome the disadvantage of the electro-mechanical brake of the related art. Specifically, the actual braking force value detection unit 133 can accurately detect the actual braking force value even when the state of the electro-mechanical brake 1 is not the first state. That is, even when the state of the electro-mechanical brake 1 continuously changes due to braking performed during traveling, the actual braking force value detection unit 133 can accurately detect the actual braking force value.

The actual braking force value detection unit 133 includes all or some of a first braking force value detection unit 134, a difference value detection unit 135, and a compensation value determination unit 136.

The first braking force value detection unit 134 determines the first braking force value based on the actual piston position detected by the position detection unit 115 and the first map 123. Specifically, the first braking force value detection unit 134 determines a value of the braking force output when the actual piston position is input to the first map 123 as the first braking force value.

Since the state of the electro-mechanical brake 1 changes from the first state when the electro-mechanical brake 1 performs braking, the first braking force value detected by the first braking force value detection unit 134 is different from the actual braking force value generated by the electro-mechanical brake 1. The electro-mechanical brake 1 according to the present disclosure compensates for the first braking force value to detect the actual braking force value. This will be described later.

The difference value detection unit 135 detects a difference between the effective value extracted by the effective value extraction unit 132 and a first current value. The first current value refers to a value of a current output when the actual piston position detected by the position detection unit 115 is input to the first map 123.

The compensation value determination unit 136 determines a difference value multiplied by a first factor value as a compensation value. The first factor value refers to a value of a factor output when the effective value is input to the second map 125. The compensation value can be used to accurately detect the actual braking force value in a state other than the first state.

When the state of the electro-mechanical brake 1 changes from the first state due to braking during traveling, the actual braking force value detection unit 133 may detect a sum of the compensation value and the first braking force value as the actual braking force value generated by the electro-mechanical brake 1. Here, a case where the state of the electro-mechanical brake 1 changes from the first state due to braking during traveling may be a case where a volume of the brake pad 250 changes due to change in temperature of the brake pad 250, or the brake pad 250 is worn. Thus, the electro-mechanical brake 1 according to the present disclosure can accurately detect the actual braking force value even when the state of the electro-mechanical brake 1 is different from the first state due to braking performed during traveling.

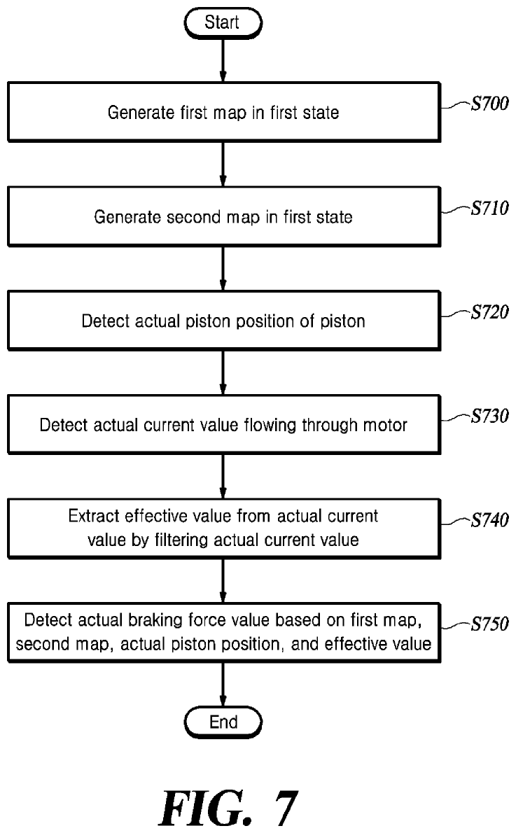

FIG. 7 is a flowchart showing a control method for an electro-mechanical brake according to an embodiment of the present disclosure.

Referring to FIG. 7, the electro-mechanical brake 1 according to the embodiment of the present disclosure may generate the first map 123 in the first state (S700). The electro-mechanical brake 1 may generate the second map 125 in the first state (S710). According to one embodiment, steps S700 and S710 may be performed simultaneously.

According to one embodiment, the electro-mechanical brake 1 may start generating the first map 123 and the second map 125 from the moment the user opens the door of the vehicle in order to complete the generation of the first map 123 and the second map 125 before traveling starts. According to one embodiment, the electro-mechanical brake 1 may start generating the first map 123 and the second map 125 from a moment electric power is applied to the vehicle due to start-up.

The electro-mechanical brake 1 may detect the actual piston position of the piston using the position detection unit 115 (S720). The electro-mechanical brake 1 may detect the actual current value flowing through the motor 210 using the current detection unit 113 (S730).

The electro-mechanical brake 1 may extract the effective value from the actual current value by filtering the actual current value (S740). Among the actual current values measured by the current detection unit 113, the actual current value that can be used for detection of the actual braking force value is called the effective value.

According to one embodiment, the electro-mechanical brake 1 may extract, as the effective value, the actual current value detected when the actual piston position is a position to which the piston has moved forward by the preset distance or more from the contact point. According to one embodiment, the electro-mechanical brake 1 may extract, as the effective value, the actual current value of which the rate in change during the specific time period has the positive value among the actual current values, in the applied state in which the piston 240 is moving forward. According to one embodiment, the electro-mechanical brake 1 may extract, as the effective value, the actual current value detected when the first braking force value is smaller than the target braking force (or the brake command). According to one embodiment, when the piston 240 moves forward, stops, and then maintains the stop state (maintains the apply-held state), the effective value extraction unit 132 may extract, as the effective value, the actual current value detected when the first braking force value is smaller than the target braking force (or the brake command) and the stop state is maintained during the threshold time period or less. According to one embodiment, when the piston 240 moves forward, stops, and then maintains the stop state (maintains the apply-held state), the effective value extraction unit 132 may extract, as the effective value, the actual current value when a rage of change in the target braking force during a control time period (or a rate of change in the brake command) remains positive.

The electro-mechanical brake 1 may detect the actual braking force value based on the first map 123, the second map 125, the actual piston position, and the effective value (S750).

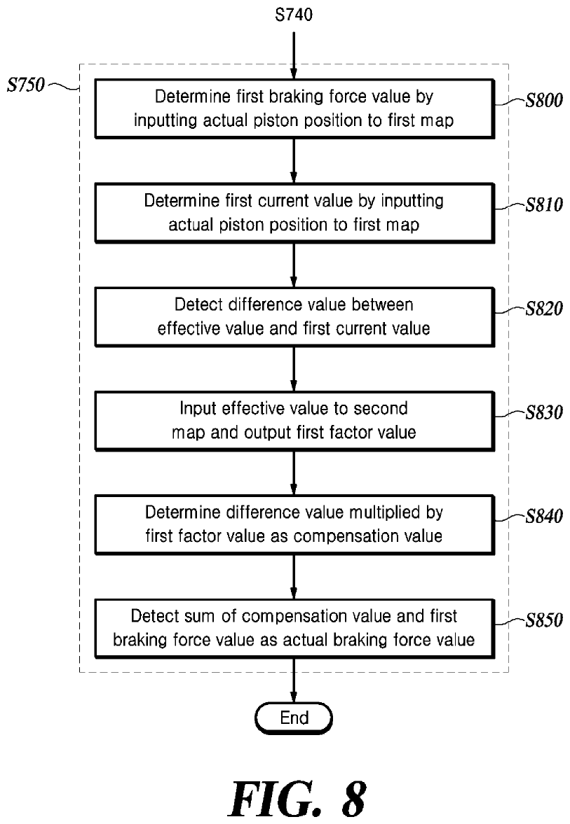

FIG. 8 is a flowchart illustrating detailed step S750 of FIG. 7 according to an embodiment of the present disclosure.

Referring to FIG. 8, step S750 of FIG. 7 may include all or some of steps S800 to S850. Specifically, the electro-mechanical brake 1 may input the actual piston position to the first map 123 to determine the first braking force value (S800). The electro-mechanical brake 1 may input the actual piston position to the first map 123 determine the first current value (S810). Steps S800 and S810 can be performed simultaneously.

The electro-mechanical brake 1 may detect the difference value between the effective value and the first current value (S820). When the effective value is greater than the first current value, this means that the rigidity of the brake pad 250 increases. When the effective value is smaller than the first current value, this means that the stiffness of the brake pad 250 decreases. Thus, the electro-mechanical brake 1 according to the present disclosure can determine whether the stiffness of the brake pad 250 has increased or decreased depending on the difference between the effective value and the first current value.

The electro-mechanical brake 1 may input the effective value to the second map 125 and output the first factor value (S830). The electro-mechanical brake 1 may determine the difference value multiplied by the first factor value as the compensation value (S840). The electro-mechanical brake 1 may detect the sum of the compensation value and the first braking force value as the actual braking force value (S850). The electro-mechanical brake 1 can accurately detect the actual braking force value by using the compensation value even when the electro-mechanical brake 1 is not in the first state. The actual braking force value refers to a value of the actual braking force generated by the electro-mechanical brake 1 when braking is performed during traveling.

Thus, the electro-mechanical brake 1 according to the present disclosure can accurately detect the actual braking force value without a force sensor, and can accurately adjust the braking force based on the detected actual braking force value. The electro-mechanical brake 1 according to the present disclosure is capable of accurate braking force adjustment, making it possible for the vehicle to behave stably and to provide a high-quality user experience due to reduced braking heterogeneity.

Compared to the electro-mechanical brake of the related art in which the accuracy of detected braking force decreases as the state changes due to traveling and braking, the electro-mechanical brake 1 according to the present disclosure accurately detects the braking force even when the state changes from the first state to another state. The electro-mechanical brake 1 according to the present disclosure can accurately detect the braking force even when calibration cannot be performed due to traveling.

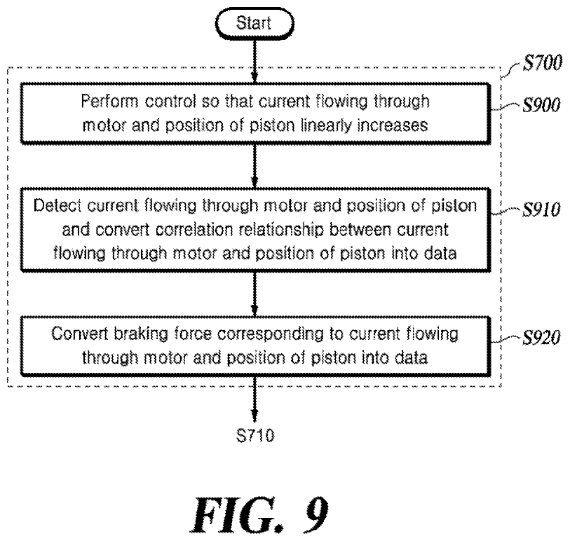

FIG. 9 is a flowchart illustrating detailed step S700 of FIG. 7 according to an embodiment of the present disclosure.

Referring to FIG. 9, step S700 of FIG. 7 may include all or some of steps S900 to S920. Specifically, the electro-mechanical brake 1 may perform control so that the current flowing through the motor 210 and/or the position of the piston 240 linearly increases (S900). For example, the RAMP control can be performed to linearly increase the current flowing through the motor 210, or the RAMP control may be performed to linearly increase the position of the piston 240. When the RAMP control is performed, the current flowing through the motor 210 can be stably measured. According to one embodiment, the electro-mechanical brake 1 may perform control so that the current flowing through the motor 210 and/or the position of the piston 240 gradually increase. In this case, the current and/or the position of the piston 240 may increase linearly or non-linearly.

The electro-mechanical brake 1 may detect the current flowing through the motor 210 and the position of the piston 240 while step S900 is performed, and convert the correlation relationship between the current flowing through the motor and the position of the piston 240 into data (S910).

The electro-mechanical brake 1 may convert the braking force corresponding to the current flowing through the motor 210 and the position of the piston 240 into data (S920). Since the current flowing through the motor 210 and the braking force have a linear relationship when the electro-mechanical brake 1 is applied (T1 in FIG. 4), it is possible to detect the braking force corresponding to the current value by detecting the current value flowing through the motor 210.

The electro-mechanical brake 1 may generate the first map 123 and/or the second map 125 using the data acquired in steps S900 to S920.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

Various implementations of systems and techniques described herein may be embodied by a programmable computer. Here, the computer includes a programmable processor, a data storage system (including volatile memory, non-volatile memory, or other types of storage systems, or combinations thereof) and at least one communication interface. For example, the programmable computer may be one of a server, a network device, a set top box, an embedded device, a computer expansion module, a personal computer, a laptop, a personal data assistant (PDA), a cloud computing system, or a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An electro-mechanical brake including a piston configured to push a brake pad toward a wheel disk through driving of a motor, the electro-mechanical brake comprising:
a current detection unit configured to detect an actual current value flowing through the motor;
a position detection unit configured to detect an actual piston position of the piston;
an effective value extraction unit configured to filter the actual current value and extract an effective value from the actual current value; and
an actual braking force value detection unit configured to detect an actual braking force value based on a first map, a second map, the actual piston position, and the effective value, wherein the first map is a map in which a correlation relationship between a current flowing through the motor, a position of the piston, and a braking force in a first state is converted into data, using a processor,
the second map is a map in which the current flowing through the motor and a factor in the first state are converted into data, using the processor, and
the factor is a ratio of the braking force to the current flowing through the motor.

2. The electro-mechanical brake of claim 1, wherein the effective value extraction unit extracts, as the effective value, the actual current value detected when the actual piston position is a position to which the piston has moved forward by a preset distance or more from a contact point.

3. The electro-mechanical brake of claim 1, wherein the effective value extraction unit extracts, as the effective value, the actual current value of which a rate of change of current during a specific time period has a positive value among the actual current values when the piston is moving forward.

4. The electro-mechanical brake of claim 1, wherein
the effective value extraction unit extracts, as the effective value, the actual current value detected when a first braking force value is smaller than a target braking force, and
the first braking force value represents a value of a braking force output from the first map when the actual piston position is provided as input.

5. The electro-mechanical brake of claim 1, wherein
when the piston moves forward, stops, and then maintains a stop state,
the effective value extraction unit extracts, as the effective value, the actual current value when a first braking force value is smaller than a target braking force and the stop state is maintained during a threshold time period or less, and
the first braking force value represents a value of a braking force output from the first map when the actual piston position is provided as input.

6. The electro-mechanical brake of claim 1, wherein
the actual braking force value detection unit includes:
a first braking force value determination unit configured to determine a value of a braking force output when the actual piston position is provided as input to the first map as a first braking force value;
a difference value detection unit configured to detect a difference value between the effective value and a first current value, the first current value being a current value output when the actual piston position is provided as input to the first map; and
a compensation value determination unit configured to determine the difference value multiplied by a first factor value as a compensation value, the first factor value being a value of a factor output when the effective value is provided as input to the second map.

7. The electro-mechanical brake of claim 6, wherein the actual braking force value detection unit detects a sum of a compensation value and the first braking force value as the actual braking force value generated by the electro-mechanical brake when the state of the electro-mechanical brake changes from the first state to another state due to braking during traveling.

8. A control method for an electro-mechanical brake including a piston configured to push a brake pad toward a wheel disk through driving of a motor, the control method comprising:
generating a first map and a second map in a first state, using a processor;
detecting an actual piston position of the piston, using a position detection unit;
detecting an actual current value flowing through the motor, using a current detection unit;
filtering the actual current value to extract an effective value from the actual current value, using an effective value extraction unit; and
detecting an actual braking force value based on the first map, the second map, the actual piston position, and the effective value, using an actual braking force value detection unit, wherein the first map is a map in which a correlation relationship between a current flowing through the motor, a position of the piston, and a braking force in the first state is converted into data, using the processor;
the second map is a map in which the current flowing through the motor and a factor in the first state are converted into data, using the processor, and
the factor is a ratio of the braking force to the current flowing through the motor.

9. The control method for an electro-mechanical brake of claim 8, wherein the filtering of the actual current value to extract the effective value from the actual current value includes using the effective value extraction unit to extract, as the effective value, the actual current value detected when the actual piston position is a position to which the piston has moved forward by a preset distance or more from a contact point.

10. The control method for an electro-mechanical brake of claim 8, wherein the filtering of the actual current value to extract the effective value from the actual current value includes using an effective value extraction unit to extract, as the effective value, the actual current value of which a rate in change during a specific time period has a positive value among the actual current values when the piston is moving forward.
